(19) United States
(12) Patent Application Publication
(10) Pub. No.: US 2006/0273111 A1
(43) Pub. Date: Dec. 7, 2006

(54) Safety caps for aerosol spray devices and methods for operating the same

(76) Inventors: Nancy S. Heatley, Chicago, IL (US); Christopher Heatley, McHenry, IL (US); Jon Larson, Sycamore, IL (US); Mike Jacobs, Johnsburg, IL (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/264,826

(22) Filed: Nov. 1, 2005

Related U.S. Application Data
(63) Continuation of application No. 11/143,812, filed on Jun. 2, 2005.

(51) Int. Cl. B67B 5/00

(52) U.S. Cl. 222/153.06

(57) ABSTRACT

Methods and apparatus are disclosed for a safety enclosure for an aerosol device that includes an overlying cap coupled to a base cap. There is also a tab on the overlying cap that prevents rotation of the overlying cap with respect to the base cap and keeps the caps locked and the underlying aerosol spray device in an inoperative position. When use of the aerosol spray device is desired, the tab is ripped away. The two caps may be rotated to either align or mis-align the openings on the caps to permit or prevent user actuation of the spray device.

### RELATED APPLICATION

This patent is a continuation of U.S. application Ser. No. 11/143,812, filed Jun. 2, 2005, which is hereby incorporated herein by reference in its entirety.

### FIELD OF THE DISCLOSURE

This disclosure relates generally to safety caps, and, more particularly, to safety caps for aerosol spray devices.

### BACKGROUND

Aerosol spray devices, such as aerosol cans have a wide variety of uses in many industries and have been used to dispense products such as cosmetics, personal care products, household cleaners, industrial cleansers, paint, insecticides, etc. A typical aerosol spray device contains the product solution (e.g., paint or cleansing product) and a propellant, usually a gas, which causes pressure within the container. The contents of the can are pressurized and, therefore, there is a greater risk that the contents maybe accidentally dispensed, such as, for example, inadvertently by an adult, by a child, if a foreign object contacts the nozzle of the aerosol device or during shipping.

Typically, aerosol devices include a safety cap or other device to prevent unwanted dispensing of the contents of the device. One example prior art safety cap is described in U.S. Pat. No. 5,836,184. The safety cap device in this disclosure includes two opposed cups that enclose the top and bottom of an aerosol can. The opposed cups have arms that extends towards each other, the ends of which have perpendicular flanges. The perpendicular flanges have slots that align when the device is completely attached to the aerosol can and are used to secure a padlock or other locking mechanism, which holds the flanges together. The top portion of the cap covers the dispensing nozzle of the aerosol can and prevents the nozzle from being activating and, consequently, prevents accidental dispensing of the contents of the can. Though this cap will prevent accidental discharging of the associated aerosol can, it requires a lock, and thus, that the user have a key or memorize a combination, depending on what type of lock is used. Further this cap is only effective to the extent that none of its pieces is missing.

Another example safety cap that is known is described in U.S. Pat. No. 4,662,542. The safety cap in this disclosure includes an externally screw threaded sleeve and a safety cap having internal threads to engage the threads on the sleeve. This device is similar to the safety caps commonly found on medicine containers. When the cap is secured to the top of an aerosol can, it prevents inadvertent dispensing of the contents of the aerosol device. If an adult desires to purposefully dispense the contents of the aerosol can, the safety cap must be removed from the can and cannot be lost if the adult wanted to re-secure the safety feature.

### BRIEF DESCRIPTION OF THE DRAWINGS

FIG. 1 is a perspective view of an example safety cap including a protective tab.

FIG. 2 is a perspective view of the safety cap of FIG. 1 having the protective tab removed and positioned to discharge aerosol content.

FIG. 3 is a perspective view of the safety cap of FIG. 1 having the protective tab removed and positioned not to discharge aerosol contents.

FIG. 4 is a perspective view of an example overcap of FIG. 1

FIG. 5 is a front elevational view of the example overcap of FIG. 4.

FIG. 6 is a side elevational view of the example overcap of FIG. 4.

FIG. 7 is a plan view of the example overcap of FIG. 4.

FIG. 8 is a bottom view of the example overcap of FIG. 4.

FIG. 9 is a cross-sectional view of the example overcap of FIG. 4 taken along the 9-9 line of FIG. 7.

FIG. 10 is an enlarged view of the encircled section of FIG. 9.

FIG. 11 is a perspective view of an example base cap of FIG. 1.

FIG. 12 is a front elevational view of the example base cap of FIG. 11.

FIG. 13 is a plan view of the example base cap of FIG. 11.

FIG. 14 is a cross-sectional view of the example base cap of FIG. 11 taken along the 14-14 line of FIG. 13.

FIG. 15 is an enlarged plan view of the encircled section of FIG. 13 showing an engagement rib.

### DETAILED DESCRIPTION

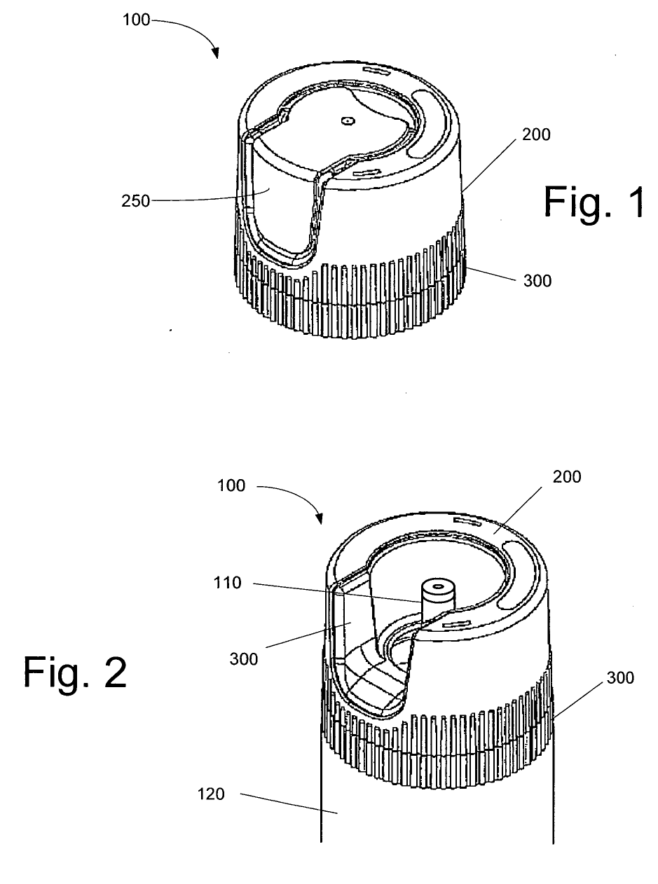

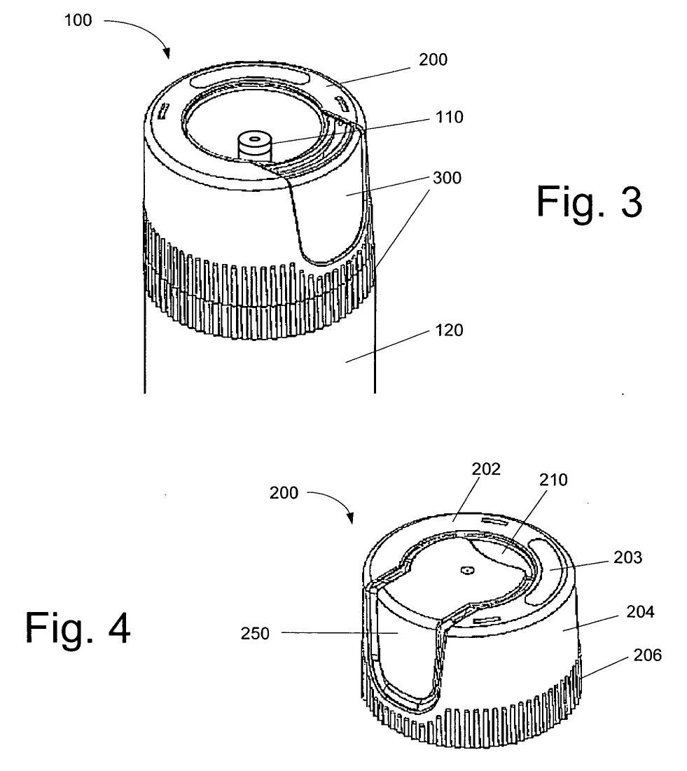

FIGS. 1-3 show a perspective view of an example safety cap 100. The safety cap 100 has an overcap 200 and a base cap 300. In the illustrated example, the overcap 200 and base cap 300 may each be plastic that is molded. The overcap 200 is sized to accommodate the base cap 300. In the illustrated example, the overcap 200 includes a removable tab 250. The safety cap 100 encloses the nozzle 110 of an aerosol can 120 (only a portion of the can 120 is illustrated in FIGS. 2 and 3). In the position shown FIG. 1, the tab 250 covers the nozzle 110 so that the aerosol can 120 cannot dispense its contents.

When it is desirable to dispense the contents of the aerosol can 120, the tab 250 is removed from the safety cap 100. Then the overcap 200 is rotated to align with the base cap 300 as shown in FIG. 2. The removal of the tab 250 and the orientation of the overcap 200 and the base cap 300 in this manner are discussed in more detail below. After the tab 250 has been removed and it is desirable to prevent the dispensation of the contents of the aerosol can 120, the overcap 200 is rotated with respect to the base cap 300 to the position shown in FIG. 3, which is also discussed in more detail below.

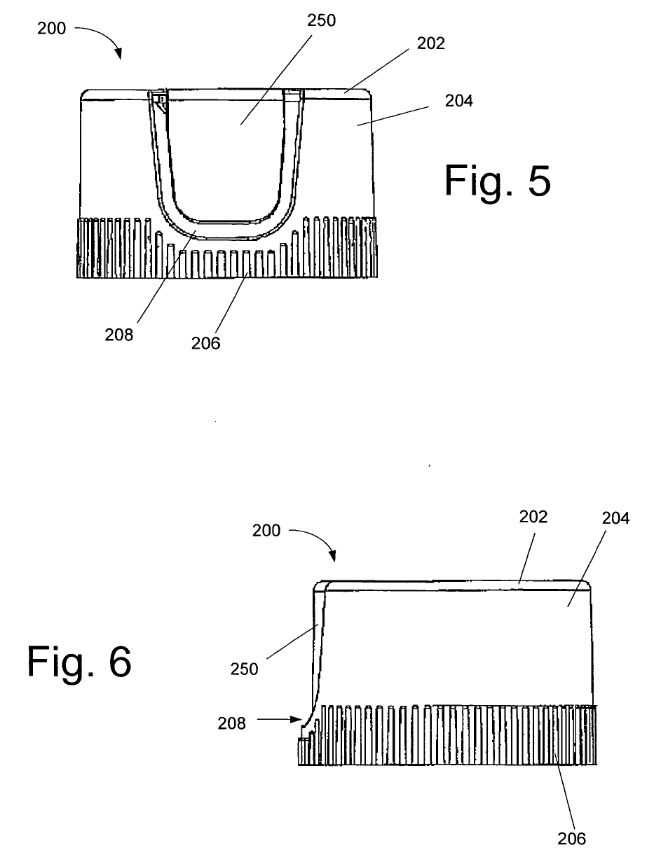

An illustrated overcap 200 is shown in FIGS. 4-8. The overcap 200 has a planar, circular top 202 and a cylindrical side 204. The planar top 202 has an area 203 in which trademarks, logos, artwork or other information can be placed (e.g., molded). The material placed in the area 203 may be removable and replaceable. The lower portion of the cylindrical side 204 has a textured surface 206 that is used to grip and rotate the overcap 200. The cylindrical side 204 of the overcap 200 also has an opening 208, which is generally u-shaped and extends up to a substantially circular-shaped opening 210 in the top 202.

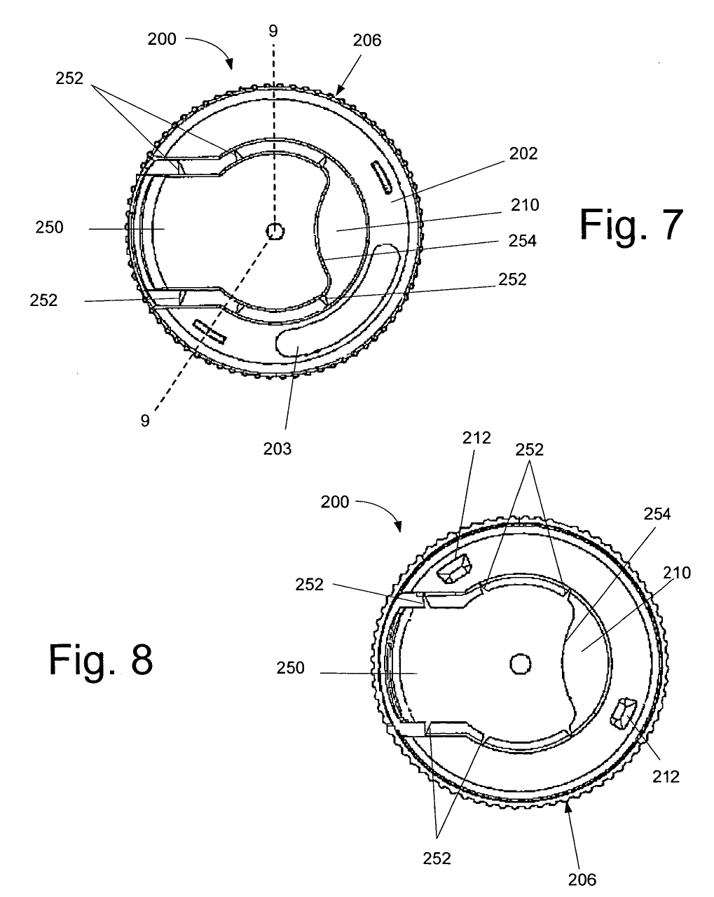

The tab 250 extends through both openings 208, 210 and is connected to the top 202 by extensions 252 that span the gap between the circular top 202 and the tab 250. The illustrated example shows six extensions (some of which are referred to using reference numeral 252 in FIGS. 7 and 8) that connect the tab 250 to the top 202 of the overcap 200, but a person of ordinary skill in the art would appreciate that any number of extensions (1, 2, 3, 7, etc.) may be used.

In the illustrated example, the lower portion of the tab 250 sits in the opening 208 and does not have any extensions 252 connecting the tab 250 to the side 204 of the overcap 200. However, in an alternative embodiment, more extensions 252 may be provided, as described above, that could secure this portion of the tab 250 to the side 204. Furthermore, the tab 250 may alternatively be connected to the base cap 30 in a manner similar to any of those described above.

The tab 250 also has a grip 254 that is spaced from the top 202 a distance sufficient to accommodate a user's finger. In an alternative embodiment, the grip 254 may be located at the bottom of the lower portion of the tab 250, spaced from the side wall 204 in the opening 208. In yet another alternative embodiment, the grip 254 may be located anywhere along the surface of the tab 250.

When a person wishes to remove the tab 250 from the overcap 200, the person applies as upward force on the tab 250 at the grip 254, which may cause the tab 250 to break away from the extensions 252. The applied force may also cause the extensions 252 to break away from the top 202. Alternatively, the extensions 252 themselves may break in half, or in any other proportion, where a portion of the extension 252 remains attached to the top 202 and a portion remains attached to the tab 250, but the two portions are not connected. Furthermore, one of ordinary skill in the art would appreciate that any extension 252 may break in any fashion described above and that all extensions 252 do not have to break in the same manner. Once all the extensions 252 have been disassociated from either the tab 250 or the top 202, the tab 250 is no longer connected to the overcap 200 and may be discarded. The overcap 200 is now rotatable for reasons that are described in further detail below.

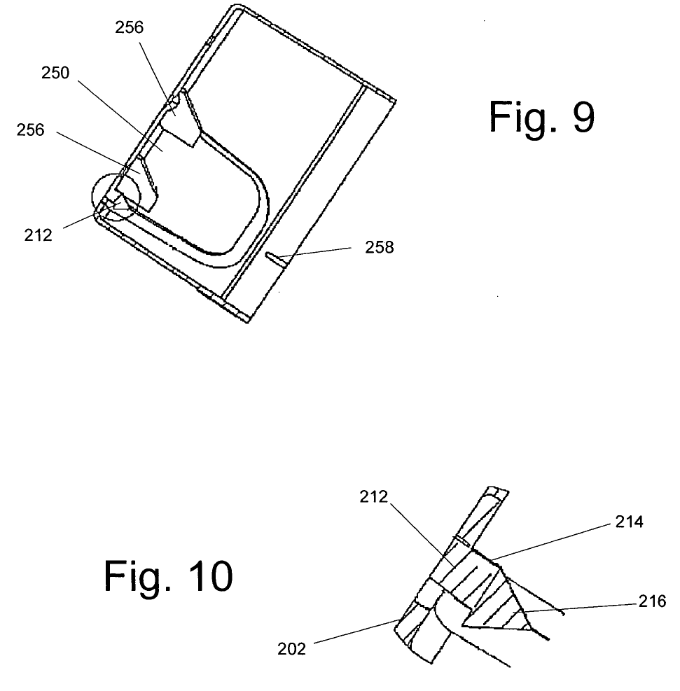

In the disclosed example, the tab 250 includes flanges 256 (as shown in FIG. 9). The flanges 256 prevent the overcap 200 from rotating with respect to the base cap 300 when the tab 250 is in place. The rotation of the overcap 200 and the operation of the flanges 256 are discussed in more detail below. Of course, in other examples, the tab 250 need not have flanges 256. In such an example, the tab 250 would still cover the opening 210 in the overcap 200 and prevent accidental discharge of the contents of the aerosol can 120 but would not prevent rotation.

The overcap 200 also has two hook shaped protrusions 212 on the underside of the top 202 (see FIG. 8). A cross-section of an example hook shaped protrusion 212 is shown in FIG. 9 and enlarged in FIG. 10. The protrusion 212 is connected to the top 202 and has a perpendicular projection 214. The projection 214 continues a short distance and ends in a barbed point 216. Though the illustrated example has two protrusions 212, one of ordinary skill in the art would appreciate that any number of protrusions 212 (e.g., 1, 3, 4, etc.) may be employed. The interaction of the protrusions 212 with the safety cap 100 is discussed in more detail below. In addition, the illustrated example shows the protrusions 212 integrally formed with the top 202. One of ordinary skill in the art would appreciate that the protrusions 212 may be separate components that are coupled to the top 202 via any known chemical or mechanical fastener.

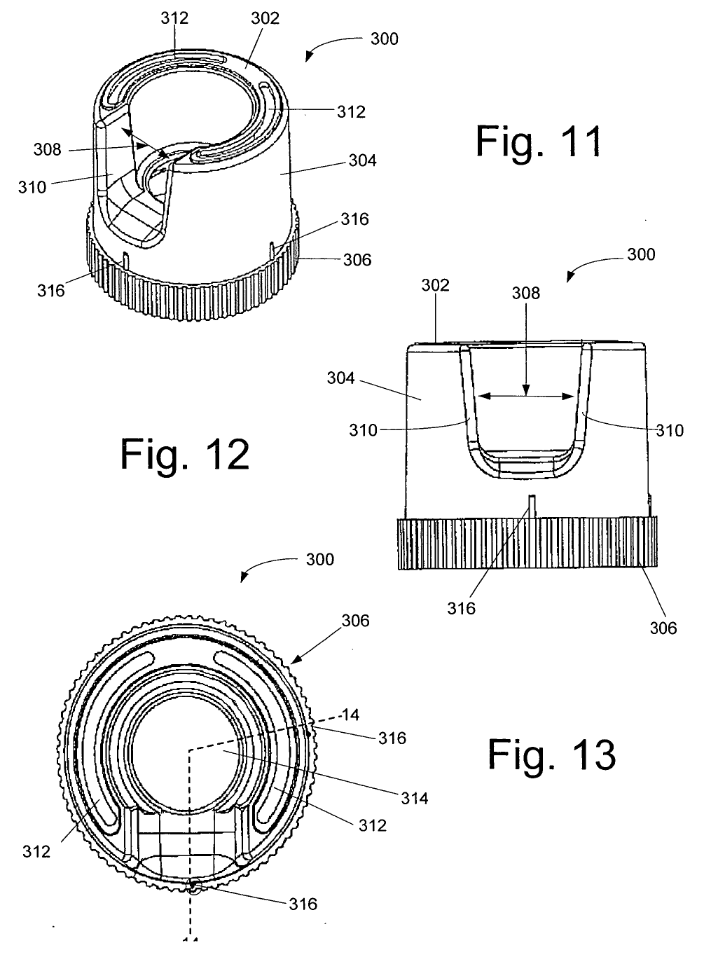

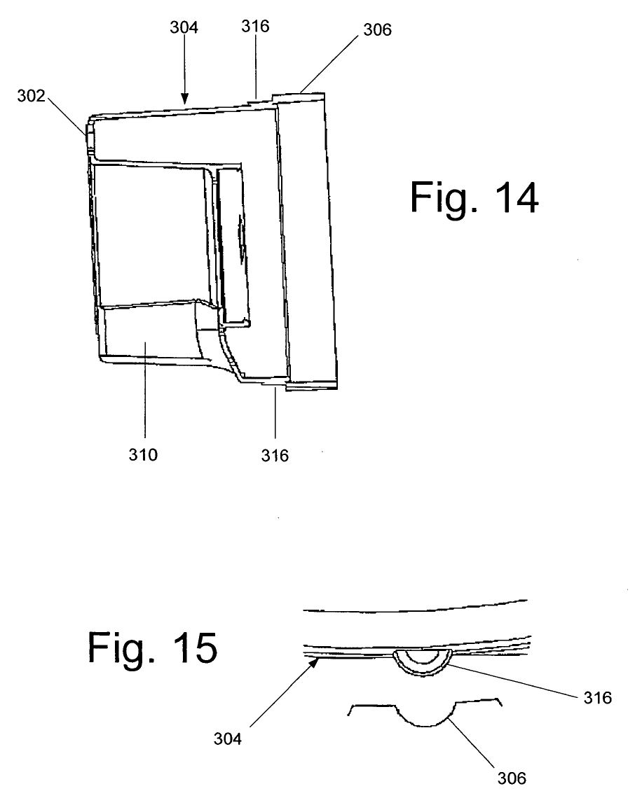

FIGS. 11-14 illustrate the base cap 300 of the disclosed example. The base cap 300 has a substantially circular, planar top 302 and cylindrical side 304. The lower portion of the cylindrical side 304 has a textured surface 306 that is used to grip and rotate the base cap 300 with respect to the overcap 200. The cylindrical side 304 also has an opening 208, which is generally u-shaped, that exposes two side walls 310. When the overcap 200 is disposed over the base cap 300 (as shown in FIG. 1), the lower portion of the tab 250 sits in the opening 308 between the two side walls 310. When the overcap 200 is moved clockwise or counterclockwise with respect to the base cap 300, the flanges 256 of the tab 250 come into contact with the side walls 310 and prevent the overcap 200 from substantially rotating with respect to the base cap 300. When the tab 250 has been removed from the overcap 200, as described above, the flanges 256 no longer make contact with the sidewalls 310 because the tab 250 is no longer disposed in the opening 308. Thus, there are no obstructions that prevent the rotation of the overcap 200 with respect to the base cap 300.

The base cap 300 also includes slots 312 in the top 302. The slots 312 run along a portion of the circumference of the top 302, reflecting the curved shape of the top 302. The slots are configured to receive the protrusions 212 of the overcap 200. The barbed end portion 216 hooks through the slot 312 and engages the underside of the top 302 of the base cap 300. This prevents the overcap 200 from becoming disassociated from the base cap 300. When the overcap 200 is rotated with respect to the base cap 300, the protrusions 212 move simultaneously in their respective slots 312. The caps 200, 300 may rotate, in either direction (clockwise or counterclockwise), up to a distance equal to the length of the shortest of the slots 312 (for example, the overcap 200 may be rotated approximately 90° with respect to the base cap 300). Additionally, a person of ordinary skill in the art would appreciate that there may be any number of slots 312 on the base cap 300 (e.g., 1, 3, 4, etc.), and there may or may not be an equivalent number of protrusions 212 on the overcap 200.

The base cap 300 also has a bottom opening 314. When the overcap 200 is disposed on top of the base cap 300, the top of the opening 210 sits above the bottom opening 314. A spray nozzle (not shown) is disposed within the openings 210, 314 and is reachable by a user after the tab 250 has been removed. When the tab 250 is secured to the top 202 of the overcap 200, the tab 250 creates a barrier that prevents activation of a spray nozzle housed in the openings 208, 314 of the caps 200, 300. This is important to prevent accidental discharge of the contents of the spray can. This is useful during the transportation, stocking or storing of aerosol cans with the caps 200, 300 because the tab 250 prevents a person or a foreign object from depressing the nozzle.

To allow for user actuation of the underlying nozzle of an aerosol can (not shown) on which the caps 200, 300 are disposed, the opening 208 along the cylindrical side 204 of the overcap 200 must substantially align with the opening 308 of the base cap 300. To align the openings 208, 308, the user grips either the textured bottom portion 206 of the overcap 200 or the textured bottom portion 306 of the base cap 300, or both, and rotates the caps 200, 300 in opposite directions until the openings 208, 308 substantially align. When the safety cap 100 is positioned such that the cap 100 is ready to use (as shown in FIG. 2), the safety cap 100 can be used, for example, in an inverted spray system in which the aerosol can is held upside down and the user's finger resides in the unshaped openings 208, 308 and can activate the nozzle to cause a discharge of the aerosol products from the nozzle and through the circular openings 210, 314 of the overcap 200 and base cap 300, respectively.

When the openings 208, 308 are not aligned, the inner surface of the wall 204 blocks the opening 308, creating a shield that prevents the user from reaching the nozzle. Preventing the accidental discharge of the contents of the aerosol spray device is particularly desirable when the contents are toxic or otherwise harmful to children, the environment or the immediate surroundings.

The base cap 300 also has engagement ribs 316 that are located along the side 304 of the case cap 300 just above the textured grip portion 306, as shown in FIGS. 11 and 12. The engagement ribs 316 are shown in plan view in FIG. 13, and one example rib 316 is shown enlarged and in plan view in FIG. 15. The engagement ribs 316 aid in aligning the openings 208, 308. When the overcap 200 is rotated with respect to the base cap 300, the engagement ribs 316 may cooperate with a corresponding indentation 258 on the over cap 200 (see FIG. 9), for example, the ribs 316 may click or snap into the indentation 258. The interaction between the ribs 316 and the indentation 258 indicate to the user that the cap 100 is open, i.e., the position shown in FIG. 2, or closed, i.e., the position shown in FIG. 3. For example, when the base cap 300 and overcap 200 are rotated with respect to each other to the point that the indentation 258 engages one of the ribs 316, the user may know, by feel or sound, that the cap 100 is open. Then the user can rotate the overcap 200 and base cap 300 again until the indentation 258 engages the other rib 316 and know that the cap 100 is closed, or vice versa. The engagement between the ribs 316 and the indentation 258 operates like a detent. Although the illustrated example discloses one indentation 258 and two ribs 316, a person of ordinary skill in the art would appreciate that any number of indentations and/or ribs may be used to indicate whether the cap 100 is opened or closed.

In an alternative embodiment, the overcap 200 is removable from the base cap 300. If the barbed portions 216 of the protrusions 212 of the overcap 200 are forced through the slots 312 of the base cap 300, the two caps 200, 300 will no longer be coupled. This configuration may be useful where less components are desired and there is no need or want to prevent an accidental expulsion of the contents of an aerosol can because when the overcap 200 is removed, the nozzle may be activated purposefully or accidentally at all times.

The bottom opening 314 and opening 208 on the overcap 200 can accommodate virtually any spray nozzle 110. This is advantageous because nozzles are configured to accommodate the materials that they disperse, so this allows for the safety cap 100 disclosed herein to be used in a variety of products throughout a variety of industries. This versatility also allows the safety cap 100 to be used on multiple aerosol cans. This is particularly beneficial if one can is empty and the user wants the features of the safety cap 100 on another can that lacks the cap 100. The user simply removes the cap 100 and secures the cap 100 to another aerosol can.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An enclosure for an aerosol device comprising:
a base portion including a first opening to accommodate a nozzle of the aerosol device and a second opening to accommodate user actuation of the nozzle;
an overcap portion coupled to the base portion and configured to move with respect to the base portion, wherein the overcap portion includes a third opening to accommodate discharge from the nozzle and a fourth opening to accommodate user actuation of the nozzle; and
a structure to facilitate alignment of the second and fourth openings.

2. An enclosure as defined in claim 1, wherein the structure comprises:
an engagement rib located on a side of the base portion; and
a corresponding indentation located on a side of the overcap portion.

3. An enclosure as defined in claim 1, wherein the overcap portion is rotatable with respect to the base portion to align the second opening and the fourth opening.

4. An enclosure as defined in claim 1, wherein the overcap portion is rotatable with respect to the base portion to move the second opening to a position located approximately ninety degrees from the fourth opening.

5. An enclosure as defined in claim 1, wherein the enclosure comprises a safety cap.

6. An enclosure as defined in claim 1 wherein the overcap portion is removable from the base portion.

7. An enclosure as defined in claim 1, further comprises a removable portion at least partially covering at least one of the first opening or the third opening, wherein the removable portion also at least partially covers at least one of the second opening or the fourth opening.

8. An enclosure as defined in claim 7, wherein the removable portion prevents substantially all rotational movement between the base portion and the overcap portion.

9. An enclosure as defined in claim 7, wherein the removable portion comprises a tab that is removably connected to the overcap portion.

10. An enclosure as defined in claim 9, wherein the tab is fabricated as a removable portion of the overcap portion.

11. An enclosure as defined in claim 9, wherein the tab is connected to the overcap by extensions.

12. An enclosure as defined in claim 7, wherein the removable portion comprises a tab that is removably connected to the base portion.

13. An enclosure as defined in claim 8 wherein the removable portion prevents rotational movement between the base portion and the overcap portion with at least one extension.

14. An enclosure as defined in claim 7 wherein the removable portion has a grip portion.

15. An enclosure as defined in claim 1 further comprising at least one flange, wherein the flange couples the overcap portion to the base portion.

16. An enclosure as defined in claim 15 wherein the flange is hooked.

17. An enclosure as defined in claim 15 wherein the flange and overcap portion are integrally formed.

18. An enclosure as defined claim 15 wherein the flange and base portion are integrally formed.

19. A dispensing device comprising:
an aerosol can;
a nozzle coupled to the aerosol can;
a cap that substantially surrounds the nozzle, which comprises:
a base portion including a first opening to accommodate the nozzle and a second opening to accommodate user actuation of the nozzle;
an overcap portion rotatably coupled to the base portion and configured to move with respect to the base portion, wherein the overcap portion includes a third opening to accommodate discharge from the nozzle and fourth opening to accommodate user actuation of the nozzle; and
a structure to facilitate alignment of the second and fourth openings.

20. An enclosure as defined in claim 19, wherein the structure comprises:
an engagement rib located on a side of the base portion; and
a corresponding indentation located on a side of the overcap portion.

21. A dispensing device as defined in claim 19, wherein the overcap portion is rotatable with respect to the base portion to move the second opening to a position located approximately ninety degrees from the fourth opening.

22. A dispensing device as defined in claim 19, wherein the cap further comprises:
a removable portion at least partially covering at least one of the first opening or the third opening, wherein the removable portion also at least partially covers at least one of the second opening or the fourth opening.

23. A dispensing device as defined in claim 22, wherein the removable portion prevents substantially all rotational movement between the base portion and the overcap portion.

24. A dispensing device as defined in claim 22, wherein the removable portion comprises a tab that is removable connected to the overcap portion.

25. A dispensing device as defined in claim 24, wherein the tab is fabricated as a removable portion of the overcap portion.

26. A dispensing device as defined in claim 24, wherein the tab is fabricated as a removable portion of the base portion.

27. A dispensing device as defined in claim 22, wherein the removable portion has a grip portion.

28. A method of operating a moveable a cap for enclosure over an aerosol device to permit or prevent dispensation of contents of the cap, the method comprising:
removing a tab from a portion of a first part of the cap; and
rotating the first part of the cap with respect to a second part of the cap until an engagement rib on the second part of the cap engages an indentation on the first part of the cap to signify alignment of an opening left by the removal of the tab with an opening in the second part of the cap to permit dispensation of the contents of the can if the openings were not already aligned, or until an engagement rib on the second part of the cap disengages an indentation on the first part of the cap to signify misalignment of an opening left by the removal of the tab and an opening the second part of the cap to prevent dispensation of the contents of the can if the openings were not already mis-aligned.

29. A method as defined in claim 28 wherein the first part of the cap and the second part of the cap are connectively coupled by at least one hooked flange.

30. A method as defined in claim 29 wherein the hooked flange is integrally formed with the first part of the cap.

31. A method as defined in claim 28 wherein the tab portion of the first part of the cap substantially prevents rotation of the first part of the cap with respect to the second part of the cap.

32. A method as defined in claim 28 wherein the tab is connected to the first portion of the cap by at least one extension.

33. A method as defined in claim 28 wherein the tab has a grip portion.

34. A method as defined in claim 28 wherein the tab further comprises at least one projection that substantially prevents movement of the first portion of the cap with respect to the second portion of the cap.

35. A method as defined in claim 28 wherein the first portion of the cap is removable from the second portion of the cap.
